(19) United States
(12) Patent Application Publication
(10) Pub. No.: US 2025/0306929 A1
(43) Pub. Date: Oct. 2, 2025

(54) CACHE DEVICE AND METHOD FOR CONTROLLING CACHE DEVICE

(71) Applicant: Fujitsu Limited, Kawasaki-shi (JP)

(72) Inventor: Tetsuya Odajima, Kawasaki (JP)

(73) Assignee: Fujitsu Limited, Kawasaki-shi (JP)

(21) Appl. No.: 19/041,402

(22) Filed: Jan. 30, 2025

(30) Foreign Application Priority Data
Mar. 28, 2024 (JP) 2024-052602

(51) Int. Cl. G06F 9/30

(52) U.S. Cl. CPC G06F 9/30043; G06F 9/3001; G06F 9/30047

(57) ABSTRACT

A cache device includes: a plurality of caches that are different from each other in a number of ports that are usable in parallel, and that are each capable of holding data to be used for execution of instructions by an arithmetic operation execution circuit; and a control circuit that controls input and output of data to and from the plurality of caches. When a cache miss occurs for an access request from the arithmetic operation execution circuit, the control circuit determines which of the plurality of caches data transferred from a memory is to be stored in, based on identification information held in a memory, and performs control to store data in the determined cache.

### CROSS-REFERENCE TO RELATED APPLICATION

This application is based upon and claims the benefit of priority of the prior Japanese Patent Application No. 2024-52602, filed on Mar. 28, 2024, the entire contents of which are incorporated herein by reference.

### FIELD

The embodiments discussed herein are related to a cache device and a method for controlling the cache device.

### BACKGROUND

A processor such as a central processing unit (CPU) includes a cache that holds a part of data stored in a main memory. When the cache holds target data for a memory access request issued from a core of the processor (cache hit), the cache outputs the data held in the cache to the core without issuing the memory access request to the main memory. With this, data access efficiency is improved, and processing performance of the processor is improved.

Japanese Laid-open Patent Publication No. 2011-128803 is disclosed as related art.

### SUMMARY

According to an aspect of the embodiments, a cache device includes: a plurality of caches that are different from each other in a number of ports that are usable in parallel, and that are each capable of holding data to be used for execution of instructions by an arithmetic operation execution circuit; and a control circuit that controls input and output of data to and from the plurality of caches. When a cache miss occurs for an access request from the arithmetic operation execution circuit, the control circuit determines which of the plurality of caches data transferred from a memory is to be stored in, based on identification information held in a memory, and performs control to store data in the determined cache.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a computer including a cache device according to one embodiment;

FIG. 2 is a diagram illustrating an outline of analysis of instructions by a compiler and allocation of data by a control unit in FIG. 1;

FIG. 3 is a diagram illustrating an example of an execution cycle in a case where a program in FIG. 2 is executed by an arithmetic operation execution unit in FIG. 1;

FIG. 4 is a flowchart illustrating an example of operations of the control unit and a cache in FIG. 1;

FIG. 5 is a flowchart illustrating another example of operations of the control unit and the cache in FIG. 1; and

FIG. 6 is a block diagram illustrating an example of a computer including a cache device according to another embodiment.

### DESCRIPTION OF EMBODIMENTS

A program to be executed by the processor is converted by a compiler into a code executable by the processor. This type of compiler generates a code for performing arithmetic operation on data to be transferred to a non-cacheable area rather than to a cache, for example, in a case where a boundary of data to be used in a task included in the program does not match a management unit of the memory.

With the cache, as a number of ports for inputting and outputting data increases, a number of parallel pieces of data increases, and access efficiency improves. With this, for example, execution efficiency in a case where the core executes instructions in a multithread manner is improved. On the other hand, as the number of ports increases, a number of control circuits and signal lines in the cache increases, and thus an implementation area and a cost of the cache increase. Accordingly, a cache capable of suppressing an increase in implementation area while improving access efficiency is desired.

In one aspect, it is an object of the present disclosure to suppress an increase in implementation area while improving access efficiency in a cache device.

Hereinafter, embodiments will be described with reference to the drawings.

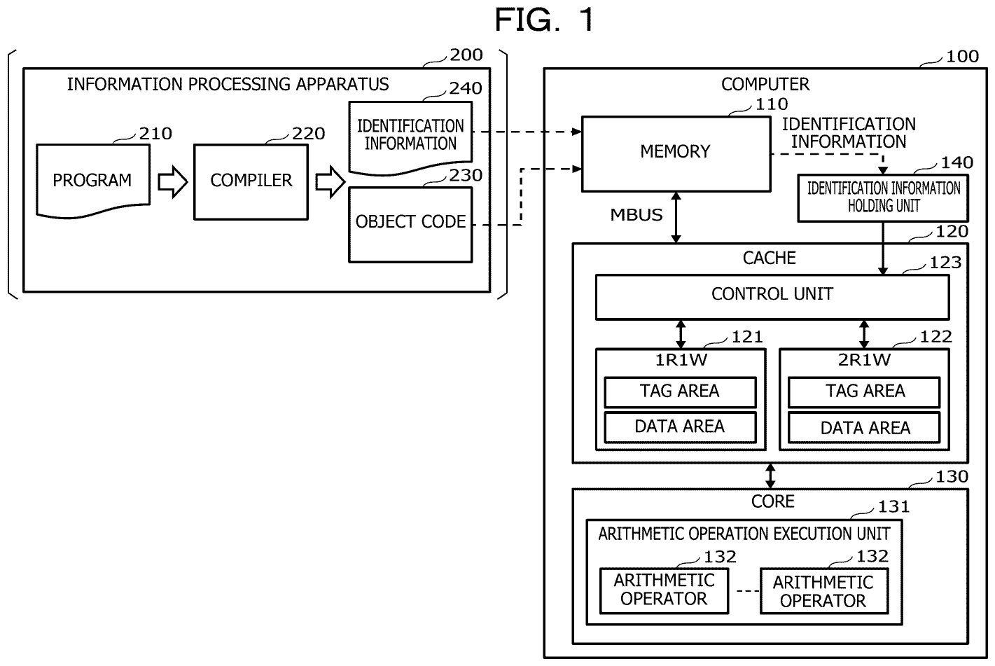

FIG. 1 illustrates an example of a computer including a cache device according to one embodiment. For example, a computer 100 illustrated in FIG. 1 includes a memory 110, a cache 120, a core 130, and an identification information holding unit 140. The cache 120 includes two types of caches 121 and 122 and a control unit 123 that controls input and output of data to and from the caches 121 and 122. The cache 121 is an example of a first cache, and the cache 122 is an example of a second cache.

For example, the cache 120 is a data cache and operates as a L3 cache. The cache 120 is an example of the cache device. The computer 100 may include an instruction cache (not illustrated) in addition to the data cache.

The core 130 includes an arithmetic operation execution unit 131 including a plurality of types of arithmetic operators 132 such as an adder, a multiplier, a multiply-and-add arithmetic operator, and an address generation arithmetic operator, and an instruction decoder, a load/store unit, a register file, and the like (not illustrated). The core 130 may include a L1 cache and a L2 cache.

The cache 120 is coupled to the memory 110 via a memory bus MBUS. The caches 121 and 122 have asymmetric structures and are different from each other in the number of ports that are usable in parallel. Compared to the cache 121, the cache 122 has a larger number of read ports and higher data read performance (high-functionality). The caches 121 and 122 may each hold data to be used for execution of instructions by the arithmetic operation execution unit 131.

For example, the cache 121 includes one read port and one write port that are usable in parallel, and may simultaneously execute one read access and one write access (1R1W type). The cache 122 includes two read ports and one write port that are usable in parallel, and may simultaneously execute two read accesses and one write access (2R1W type).

The cache 120 may include, as the caches 121 and 122, a cache having one read port and one write port that are exclusively usable and a cache having one read port and one write port that are usable in parallel. The cache 120 may include the cache 121 including one read port and one write port that are exclusively usable and the cache 122 including two read ports and one write port that are usable in parallel. In the cache having one read port and one write port that are exclusively usable, the read port and the write port may not be used simultaneously.

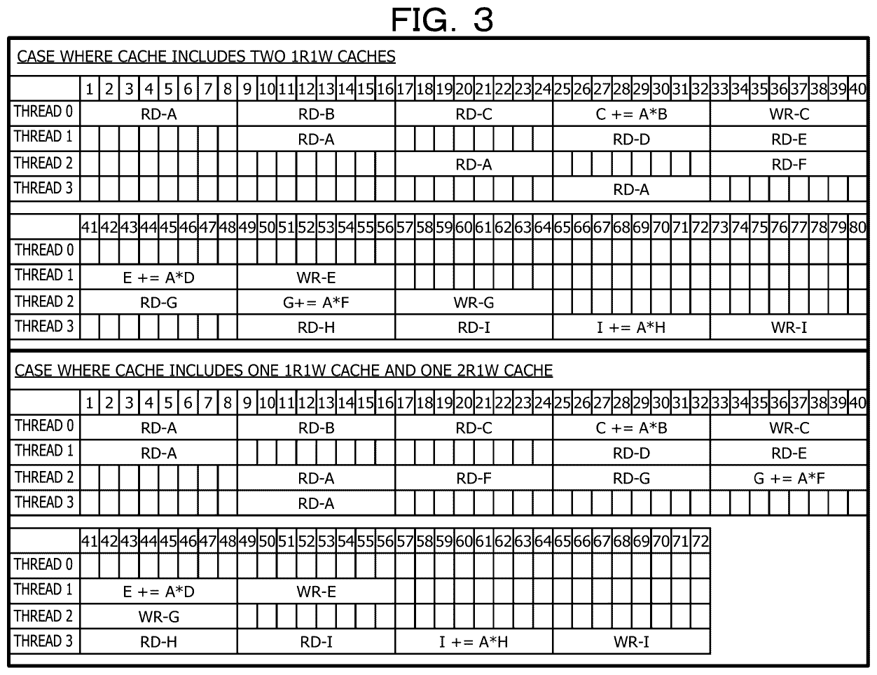

For example, in a case where only the cache 122 is mounted in the cache 120, it is possible to realize the computer 100 having higher arithmetic performance than in a case where only the cache 121 is mounted in the cache 120, but the implementation area of the cache 120 increases and the cost increases. Accordingly, by mounting two types of caches 121 and 122 having different read performances in the cache 120 in this embodiment, the computer 100 having higher arithmetic performance than the case of mounting only the cache 121 is realized while suppressing an increase in cost. The arithmetic performance will be described with reference to FIG. 3.

For example, the memory 110 may be a main storage device. When a cache such as a L1 cache or a L2 cache is mounted in the core 130, the cache 120 is a last level cache (LLC) such as a L3 cache.

For example, each of the caches 121 and 122 includes a tag area and a data area. Information indicating a memory address of data held in the cache 121 (or 122) and information indicating coherency or the like of the data held in the cache 121 (or 122) are held in the tag area. The memory address is an address allocated to an area holding access-target data in the memory 110.

The data area may include a plurality of areas that hold data for each data input to and output from the core 130, or may include a plurality of areas (for example, cache lines) that hold a plurality of pieces of data having continuous memory addresses. The tag area may be provided in common to the caches 121 and 122.

When data is stored in the cache 120, the control unit 123 uses identification information held in the identification information holding unit 140 to determine which of the caches 121 and 122 the data is to be stored in. The control unit 123 couples the determined one of the caches 121 and 122 to the memory bus MBUS. The data read from the memory 110 is stored in the cache 121 or 122 determined by the control unit 123. For example, storage of data from the memory 110 to the cache 120 is performed at the time of a cache miss in which data to be used by the arithmetic operation execution unit 131 is not held in the cache 120.

For example, the identification information holding unit 140 includes a memory that holds the identification information transferred from the memory 110. The identification information includes information on which of the caches 121 and 122 data is to be stored in, in association with the address (memory address) of the memory 110 that holds the data to be used for execution of instructions by the arithmetic operation execution unit 131. For example, in this embodiment, the identification information includes a memory address of data to be stored in the high-functionality cache 122. However, a memory address of data to be stored in the low-functionality cache 121 may be included, and addresses of data to be stored in the caches 121 and 122 may be included in correspondence with the caches 121 and 122, respectively.

The identification information may include the information on which of the caches 121 and 122 data is to be stored in, in association with an address range including the address of the memory 110 holding the data to be used for execution of the instructions. The identification information holding unit 140 may be provided in the cache 120.

For example, a program to be executed by the computer 100 (instructions to be executed by the arithmetic operation execution unit 131) is compiled by a compiler 220 mounted in an information processing apparatus 200 such as a server. By compiling a program 210, the compiler 220 generates an object code 230 (binary code) that is executable by the arithmetic operation execution unit 131. The object code 230 is an example of an instruction code.

By the compiler 220 analyzing the instructions included in the program 210 at the time of compiling the program 210, identification information 240 is generated together with the object code 230. For example, in order to further improve the arithmetic performance of the arithmetic operation execution unit 131, the compiler 220 analyzes which data among the data used in the program 210 is to be stored in the high-functionality cache 122, and outputs the analysis result as the identification information 240.

The object code 230 and the identification information 240 output by the compiler 220 are transferred to the memory 110 by an operating system (OS) executed by the computer 100. The identification information 240 transferred to the memory 110 is further transferred to the identification information holding unit 140 before the execution of the instructions by the arithmetic operation execution unit 131 is started. Dashed arrows in the drawing indicate transfer paths of the object code 230 and the identification information 240 by the OS. The transfer of the object code 230 and the identification information 240 by the OS is performed before the computer 100 executes an application program for computation processing.

For example, the compiler 220 may output, as the identification information 240, the address of the memory 110 holding the data to be stored in the cache 122. Alternatively, the compiler 220 may output, as the identification information 240, an address range of the memory 110 holding a plurality of pieces of data to be stored in the cache 122.

As described above, the control unit 123 performs control of storing data read from the memory 110 in any of the caches 121 and 122 having different performances based on the identification information held in the identification information holding unit 140. With this, it is possible to improve data access efficiency in a case where the arithmetic operation execution unit 131 executes instructions. Consequently, an instruction execution cycle may be shortened, and the processing performance of the computer 100 may be improved.

A cache having the similar configuration as the cache 120 may be mounted in the core 130 as one or both of the L1 cache and the L2 cache. In this case, the computer 100 may include a normal L3 cache instead of the cache 120. For example, two types of caches 121 and 122 having different read performances may be mounted in one or more of the caches in a plurality of tiers.

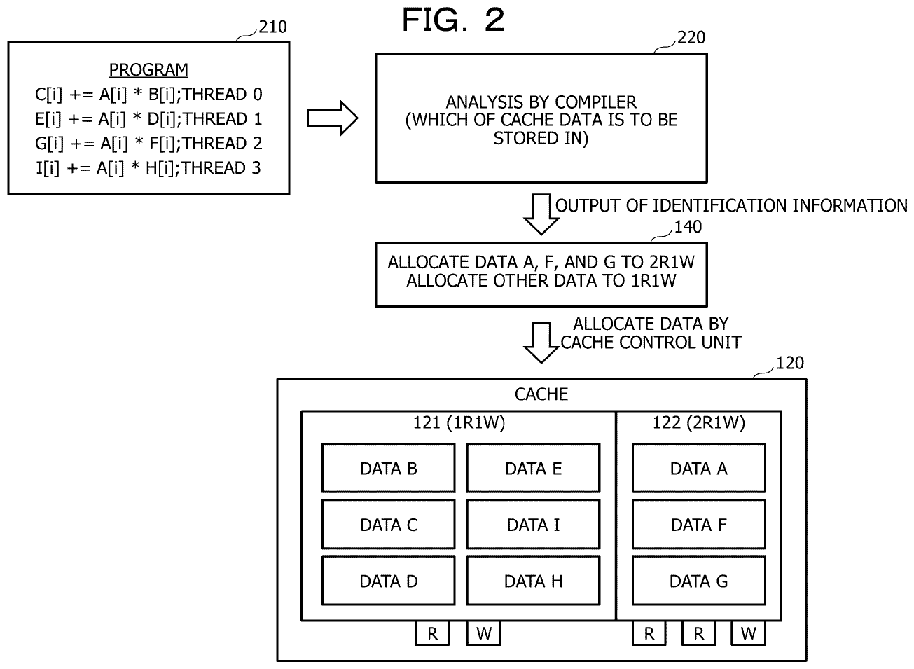

FIG. 2 illustrates an outline of analysis of instructions by the compiler 220 and allocation of data by the control unit 123 in FIG. 1. In the example illustrated in FIG. 2, each of four processes executed by the program 210 includes any one of threads 0 to 3. For example, each thread executes a multiply-and-add arithmetic operation of multiplying two pieces of data (data A and data B, data A and data D, data A and data F, or data A and data H) and adding the multiplication result to data (data C, data E, data G, or data I).

For example, the compiler 220 analyzes dependencies of pieces of data to be used in the instructions included in the program 210. In order to minimize an average of read access times from the cache 121 for data to be used by the arithmetic operation execution unit 131, the compiler 220 determines whether to hold the data in the low-functionality cache 120 or in the high-functionality cache 122. For example, the compiler 220 analyzes whether the arithmetic operation time by the arithmetic operation execution unit 131 may be reduced by allocating a storage destination of the data to be used by each instruction to the cache 121 or 122. The compiler 220 outputs the analysis result as identification information.

In the example illustrated in FIG. 2, the analysis processing, the compiler 220 determines that the data A has dependency between the processes because the data A is included in each thread of the four processes, and that data other than the data A has no dependency between the processes. In order to optimize a number of instructions to be simultaneously executed, the compiler 220 determines that it is preferable to store the data F and the data G in a cache different from a cache that stores the data other than the data A in the analysis processing. As the analysis result, the compiler 220 outputs identification information indicating that the data A, the data F, and the data G are to be allocated to the cache 122 (2R1W type) and the other data are to be allocated to the cache 121 (1R1W type).

In the example of the program 210 illustrated in FIG. 2, the compiler 220 may determine to store the data B and the data C in the cache different from the cache that stores the data other than the data A. Alternatively, the compiler 220 may determine to store the data D and the data E in the cache different from the cache that stores the data other than the data A, and may determine to store the data H and the data I in the cache different from the cache that stores the data other than the data A.

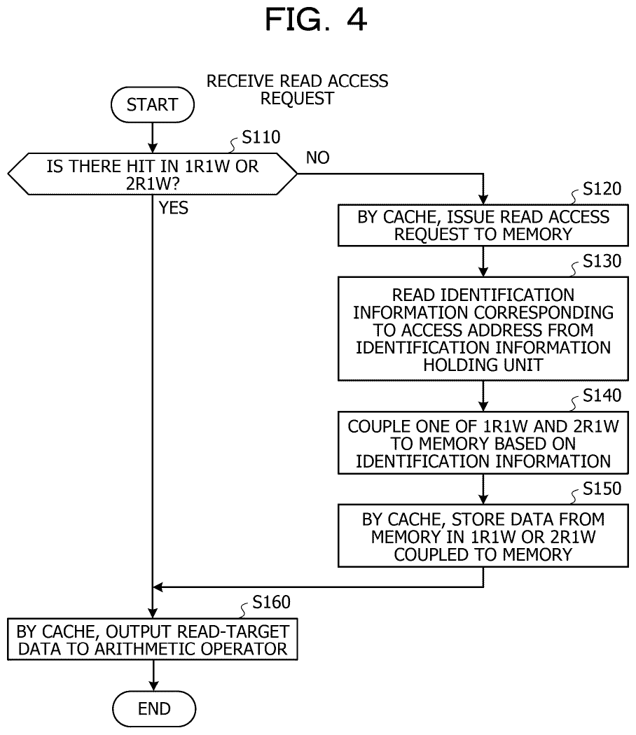

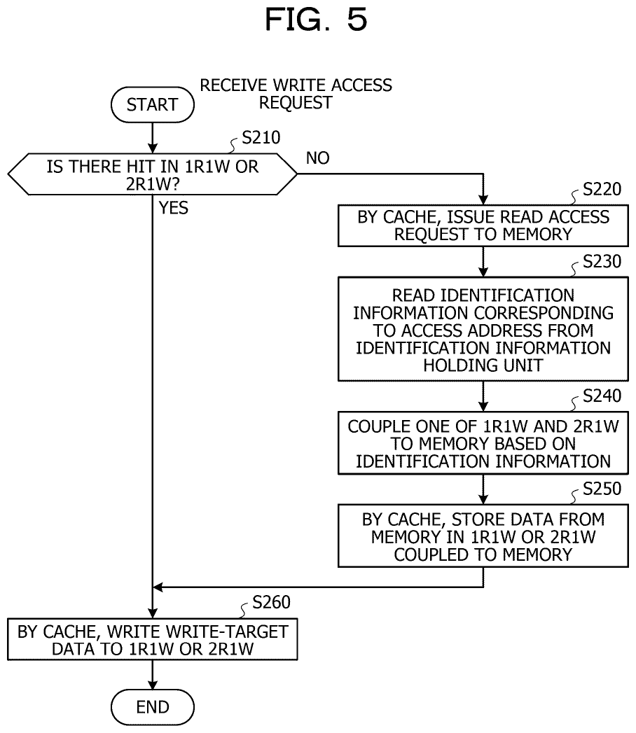

As will be described with reference to FIGS. 4 and 5, when a cache miss occurs during the execution of the program 210 (for example, the object code 230) by the arithmetic operation execution unit 131, the control unit 123 refers to the identification information holding unit 140. The control unit 123 determines which of the caches 121 and 122 is a storage destination to which the data read from the memory 110 is to be stored in the cache 120.

At a time point when all the data A to the data G are used by the program executed by the arithmetic operation execution unit 131, the state of the cache 120 holding the data A to the data G is as illustrated in FIG. 2. Reference signs R and W indicated in the caches 121 and 122 denote a read port and a write port, respectively.

FIG. 3 illustrates an example of an execution cycle in a case where the program 210 in FIG. 2 is executed by the arithmetic operation execution unit 131 in FIG. 1. An upper side of FIG. 3 indicates an example of an operation in a case where it is assumed that the cache 120 includes two caches 121 (1R1W type). A lower side of FIG. 3 indicates an example of an operation in a case where the cache 120 includes one cache 121 (1R1W type) and one cache 122 (2R1W type) as illustrated in FIG. 1. Hereinafter, the 1R1W type cache 121 and the 2R1W type cache 122 may be referred to as a 1R1W cache and a 2R1W cache, respectively.

Reference sign RD denotes a read cycle in which a read operation (load instruction) is executed, and an alphabet after a hyphen indicates data read from a cache. Reference sign WR denotes a write cycle in which a write operation (store instruction) is executed, and an alphabet after a hyphen indicates data written to a cache.

In the example illustrated in FIG. 3, it is assumed that all pieces of data to be used for an arithmetic operation are held in the cache 120 and a cache hit occurs in all accesses. It is assumed that the execution cycles of each of the read operation, the write operation, and the multiply-and-add arithmetic operation are eight cycles. It is assumed that access to the cache 120 is executed by using three load/store units. Since the multiply-and-add arithmetic operation is executed by the arithmetic operation execution unit 131, the multiply-and-add arithmetic operation may be executed in an overlapping manner with the read cycle and the write cycle.

When the cache 120 includes two 1R1W type caches 121, the arithmetic operation execution unit 131 may execute two read cycles at maximum every eight cycles. In this case, the number of cycles taken for each of the thread 0 to the thread 3 to execute the multiply-and-add arithmetic operation once each is 80 cycles.

When the cache 120 includes one 1R1W cache and one 2R1W cache, the arithmetic operation execution unit 131 may execute three read cycles at maximum every eight cycles. In this case, the number of cycles taken for the thread 0 to the thread 3 to execute the multiply-and-add arithmetic operation once each is 72 cycles. Accordingly, by using the high-functionality 2R1W type cache as a part of the cache 120, for example, an operation speed may be increased by a factor of 1.11 (=80/72).

Consequently, it is possible to realize the computer 100 having high arithmetic performance compared with the case where only the cache 121 is mounted in the cache 120. In this case, the implementation area of the cache 120 may be reduced as compared with a case where the entire cache 120 is a high-functionality 2R1W type cache. Accordingly, the cache 120 illustrated in FIG. 1 may suppress an increase in implementation area while improving access efficiency.

FIG. 4 illustrates an example of an operation of the cache 120 in FIG. 1. The operation illustrated in FIG. 4 is started based on reception of a read access request by the cache 120 from the arithmetic operation execution unit 131. The operation of the cache 120 is controlled by the control unit 123.

When the cache 120 receives the read access request from the arithmetic operation execution unit 131, in step S110, the control unit 123 determines whether there is a hit in the 1R1W cache or the 2R1W cache. When there is a hit in either the 1R1W cache or the 2R1W cache, step S160 is performed. When a miss occurs in both the 1R1W cache and the 2R1W cache, step S120 is performed.

In step S120, the control unit 123 issues a read access request to the memory 110. Next, in step S130, the control unit 123 reads identification information corresponding to an access address included in the read access request from the identification information holding unit 140.

In step S140, the control unit 123 then selects one of the 1R1W cache and the 2R1W cache in which read-target data is to be stored, based on the read identification information, and couples the selected cache to the memory 110. For example, the 1R1W cache or the 2R1W cache and the memory 110 are coupled via a multiplexer controlled by the control unit 123.

In step S150, the control unit 123 stores the data output from the memory 110 in the 1R1W cache or the 2R1W cache coupled to the memory 110. After step S150, step S160 is performed.

In step S160, the cache 120 outputs the read-target data to the arithmetic operation execution unit 131, and the operation illustrated in FIG. 4 ends.

When a miss occurs in the 1R1W cache or the 2R1W cache, data may be purged from the missed 1R1W cache or the 2R1W cache to the memory 110 in order to secure an area for storing the read-target data. However, in FIG. 4, it is assumed that there is a free space in the 1R1W cache and the 2R1W cache, and data purging does not occur. When data purging occurs, data purging processing is performed between steps S140 and S150.

FIG. 5 illustrates another example of operations of the control unit 123 and the cache 120 illustrated in FIG. 1. Detailed description of the same operations as that in FIG. 4 will be omitted. Operations in steps S210, S220, S230, S240, and S250 are similar to the operations in steps S110, S120, S130, S140, and S150 in FIG. 4, respectively. For example, when a miss occurs in the 1R1W cache and the 2R1W cache, data corresponding to write-target data is read from the memory 110, and the read data is stored in the 1R1W cache or the 2R1W cache selected based on the identification information.

When there is a hit in the 1R1W cache or the 2R1W cache, or after step S250 is executed due to a cache miss, step S260 is performed. In step S260, the cache 120 writes the write-target data to the write-target 1R1W cache or 2R1W cache indicated by the identification information. The operations illustrated in FIG. 5 end.

When a miss occurs in the 1R1W cache and the 2R1W cache, in step S260, the cache 120 overwrites the 1R1W cache or the 2R1W cache in which the data from the memory 110 is stored with the write-target data.

For example, it is assumed that a unit size (size of a cache line) of data input and output between the cache 120 and the memory 110 is larger than a unit size (size of a register file) of data read and written between the cache 120 and the arithmetic operation execution unit 131. In this case, after data of the cache line size is stored in the 1R1W cache or the 2R1W cache from the memory 110 at the time of a cache miss, the write-target data output from the arithmetic operation execution unit 131 is overwritten.

With this embodiment described above, the control unit 123 stores data read from the memory 110 in any of the caches 121 and 122 having different performances based on the identification information held in the identification information holding unit 140. With this, the data access efficiency may be improved when the arithmetic operation execution unit 131 executes the instructions, and the instruction execution cycle may be shortened. As a result, the processing performance of the computer 100 may be improved.

In this case, for example, it is possible to realize the computer 100 having higher arithmetic performance than in a case where only the cache 121 having a low-functionality is mounted in the cache 120. For example, the implementation area of the cache 120 may be reduced as compared with the case where the entire cache 120 is a high-functionality 2R1W type cache. Consequently, it is possible to suppress the increase in implementation area while improving the access efficiency of the cache 120.

The identification information includes information on which of the caches 121 and 122 data is to be stored in, in association with the memory address of the data to be used for execution of the instructions. With this, the control unit 123 may determine the cache 121 or 122 in which data is to be stored based on the address, and may simplify the control of distributing data to the caches 121 and 122. By setting the identification information to the address range, for example, the control of distributing data to the caches 121 and 122 may be further simplified.

By the compiler 220 analyzing the instructions included in the program 210 at the time of compiling the program 210, identification information is generated together with the object code 230. Accordingly, the control unit 123 may select the cache 121 or 122 in which data is to be stored, based on the identification information appropriately generated in order to shorten the instruction execution cycle.

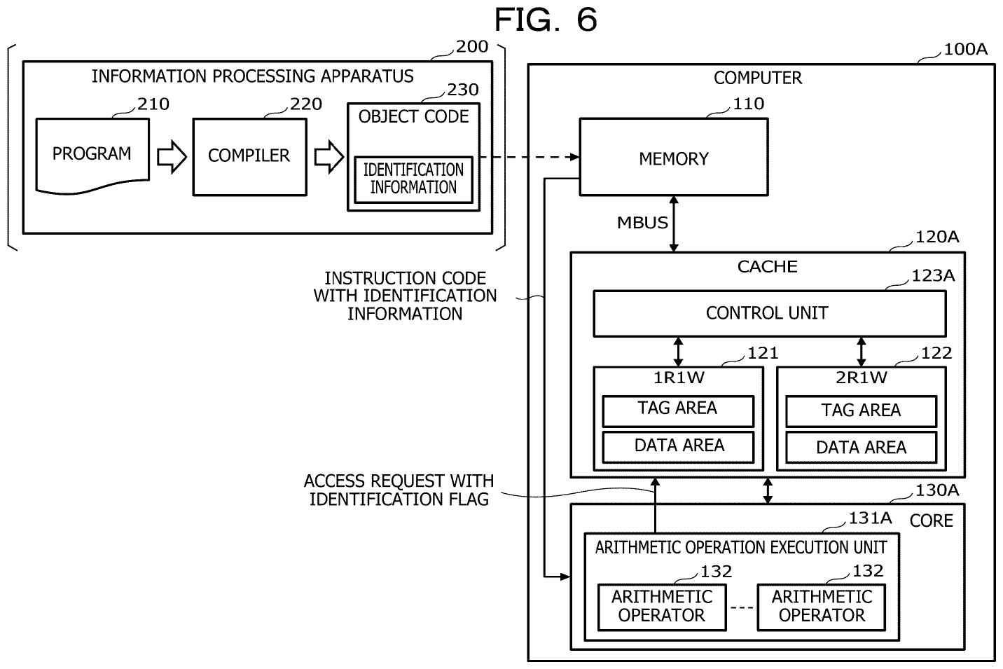

FIG. 6 illustrates an example of a computer including a cache device according to another embodiment. The same elements as those in FIG. 1 are designated by the same reference signs, and detailed description will be omitted. In this embodiment, the compiler 220 embeds identification information generated by analyzing the program 210 at the time of compiling in the object code 230.

For example, the compiler 220 adds a flag to an instruction code (for example, a load instruction) that uses data to be stored in the high-functionality cache 122. Consequently, the identification information is transferred to the memory 110 together with the object code 230 by the OS. Hereinafter, the flag added to the instruction code to identify the data to be stored in the cache 122 is referred to as an identification flag.

A computer 100A illustrated in FIG. 6 has the similar configuration and functions as those of the computer 100 illustrated in FIG. 1 except that a cache 120A and an arithmetic operation execution unit 131A are included instead of the cache 120 and the arithmetic operation execution unit 131 illustrated in FIG. 1 and does not include the identification information holding unit 140 illustrated in FIG. 1. The object code (instruction code with identification information) held in the memory 110 is fetched by the arithmetic operation execution unit 131A via an instruction cache (not illustrated). The cache 120A has the similar configuration and functions as those of the cache 120 illustrated in FIG. 1 except that a control unit 123A is included instead of the control unit 123 illustrated in FIG. 1.

When an identification flag is added to an instruction code decoded by an instruction decoder (not illustrated), the arithmetic operation execution unit 131A outputs an access request with an identification flag to the cache 120A. For example, the access request with an identification flag is a read access request corresponding to a load instruction or a write access request corresponding to a store instruction.

When a cache miss occurs in the read access request or the write access request with an identification flag, which is received from a core 130A, the control unit 123A selects the 2R1W cache and couples the 2R1W cache to the memory 110. When a cache miss occurs in the read access request or the write access request without an identification flag, which is received from the core 130A, the control unit 123A selects the 1R1W cache and couples the 1R1W cache to the memory 110.

When a cache hit occurs in the read access request or the write access request received from the core 130A, the cache 120A outputs data from the hit cache 121 (or 122) to the arithmetic operation execution unit 131A regardless of the presence or absence of the identification flag.

With the above configuration, the similar functions as those of the computer 100 illustrated in FIGS. 1 to 5 may be realized by the computer 100A. When a cache miss occurs for the read access request, the control unit 123A uses the identification flag added to the read access request as the identification information instead of performing step S130 in FIG. 4. Similarly, when the cache 120A determines a cache miss of the write access request, the control unit 123A uses the identification flag added to the write access request as the identification information instead of performing step S230 in FIG. 5.

Thus, also in the embodiment illustrated in FIG. 6, the same effect as that of the embodiment illustrated in FIGS. 1 to 5 may be achieved. For example, based on the access request with the identification flag, which is received from the core 130A, the control unit 123A stores data read from the memory 110 in any of the caches 121 and 122 having different performances. With this, the data access efficiency may be improved when the arithmetic operation execution unit 131A executes instructions, and the instruction execution cycle may be shortened. As a result, the processing performance of the computer 100A may be improved. Accordingly, it is possible to suppress the increase in implementation area while improving the access efficiency of the cache 120A.

By the compiler 220 analyzing the instructions included in the program 210 at the time of compiling the program 210, the identification information is added as an identification flag to the instruction code in the object code 230. Accordingly, the control unit 123A may select the cache 121 or 122 in which data is to be stored, based on the identification flag appropriately added in order to shorten the instruction execution cycle.

The features and advantages of the embodiments are apparent from the above detailed description. The scope of claims is intended to cover the features and advantages of the embodiments described above within a scope not departing from the spirit and scope of right of the claims. Any person having ordinary skill in the art may easily conceive every improvements and changes. Accordingly, the scope of inventive embodiments is not intended to be limited to that described above and may rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A cache device comprising:
a plurality of caches that are different from each other in a number of ports that are usable in parallel, and that are each capable of holding data to be used for execution of instructions by an arithmetic operation execution circuit; and
a control circuit that controls input and output of data to and from the plurality of caches, wherein
when a cache miss occurs for an access request from the arithmetic operation execution circuit, the control circuit determines which of the plurality of caches data transferred from a memory is to be stored in, based on identification information held in a memory, and performs control to store data in the determined cache.

2. The cache device according to claim 1, wherein
the identification information includes information on which of the plurality of caches data is to be stored in, in association with an address of the memory that holds the data to be used for execution of the instructions by the arithmetic operation execution circuit.

3. The cache device according to claim 1, wherein
the identification information includes information on which of the plurality of caches data is to be stored in, in association with an address range that includes an address of the memory that holds the data to be used for execution of the instructions by the arithmetic operation execution circuit.

4. The cache device according to claim 1, wherein
the identification information is information that is generated together with an instruction code by a compiler that compiles the instructions executable by the arithmetic operation execution circuit by analyzing the instructions, and that is transferred to the memory before the execution of the instructions by the arithmetic operation execution circuit is started.

5. A cache device comprising:
a plurality of caches that are different from each other in a number of ports that are usable in parallel, and that are each capable of holding data to be used for execution of instructions by an arithmetic operation execution circuit; and
a control circuit that controls input and output of data to and from the plurality of caches, wherein
when a cache miss occurs for an access request from the arithmetic operation execution circuit, the control circuit determines which of the plurality of caches data from a memory is to be stored in, based on identification information received from the arithmetic operation execution circuit, and performs control to store data in the determined cache.

6. The cache device according to claim 5, wherein
the identification information is added to an instruction code to be executed by the arithmetic operation execution circuit.

7. The cache device according to claim 6, wherein
the identification information is information that is generated by a compiler that compiles instructions executable by the arithmetic operation execution circuit by analyzing the instructions, and is added to the instruction code generated by the compiler.

8. The cache device according to claim 1, wherein
the plurality of caches are a first cache and a second cache,
the first cache includes one read port and one write port that are usable in parallel, or one read port and one write port that are exclusively usable, and
the second cache includes two read ports and one write port that are usable in parallel.

9. The cache device according to claim 1, wherein
the plurality of caches are a first cache and a second cache,
the first cache includes one read port and one write port that are exclusively usable, and
the second cache includes one read port and one write port that are usable in parallel.

10. A method for controlling a cache device including a plurality of caches that are different from each other in a number of ports that are usable in parallel, and that are each capable of holding data to be used for execution of instructions by an arithmetic operation execution circuit, the method comprising:
controlling input and output of data to and from the plurality of cache;
when a cache miss occurs for an access request from the arithmetic operation execution circuit, determining which of the plurality of caches data transferred from a memory is to be stored in, based on identification information held in a memory; and
performing control to store data in the determined cache.
